(19) United States
(12) Patent Application Publication
(10) Pub. No.: US 2012/0250098 A1
(43) Pub. Date: Oct. 4, 2012

(54) IMAGE FORMING APPARATUS TO DETECT DENSITY UNEVENNESS AND DENSITY UNEVENNESS DETECTION DEVICE

(76) Inventor: Makoto IKEDA, Tokyo (JP)

(21) Appl. No.: 13/429,032

(22) Filed: Mar. 23, 2012

(30) Foreign Application Priority Data
Mar. 28, 2011 (JP) JP2011-069208

(51) Int. Cl. H04N 1/00

(52) U.S. Cl. 358/406

(57) ABSTRACT

An image forming apparatus comprising: an image forming section to carry out image formation of a linear test pattern; a measurement section to measure a line width of one line of the linear test pattern at a plurality of measurement points; and a detection section to detect density unevenness, wherein the detection section converts the measured line width into density and, eliminates a measurement point where the measured line width thereof is at most a predetermined value to detect density unevenness in an extending direction of the linear test pattern.

### RELATED APPLICATION

The present application is based on Patent Application No. 2011-69208 filed at the Japan Patent Office on Mar. 28, 2011 and which is hereby incorporated herein in its entirety.

### TECHNICAL FIELD

The present invention relates to an image forming apparatus to detect density unevenness resulting from the image forming apparatus.

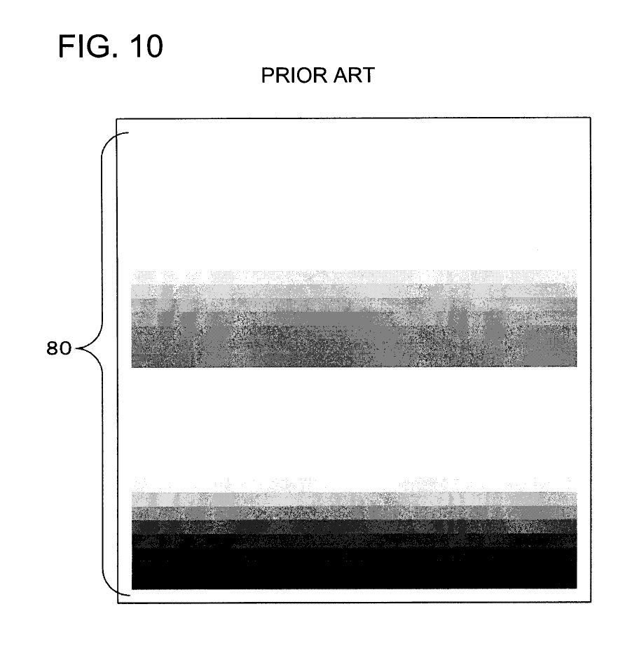

Conventionally, in image forming apparatuses such as printers, copiers, and multifunction peripherals, due to the change of characteristics caused by product deterioration and parts replacement, density unevenness has occasionally caused a decrease in image quality. To inhibit the decrease of image quality, as a measurement chart, a patch pattern 80 having a plurality of gradations for each color as sown in FIG. 10 is formed and then its image quality is measured and corrected.

Further, a technique is known in which when a line having a given width is subjected to image formation, by use of the fact that there is a correlation between the line width of the line and the density, the density is indirectly measured. For example, Unexamined Japanese Patent Application Publication No. 4-215672 proposes an image forming apparatus in which in a non-image region located in the side portion of the image region of a photoreceptor, a large number of black linear patterns are formed and then based on the detected value of reflective light from a plurality of linear patterns present in a unit measurement region, toner density is calculated to correct an image. For example, the direction of a black linear patterns are the sub scanning direction.

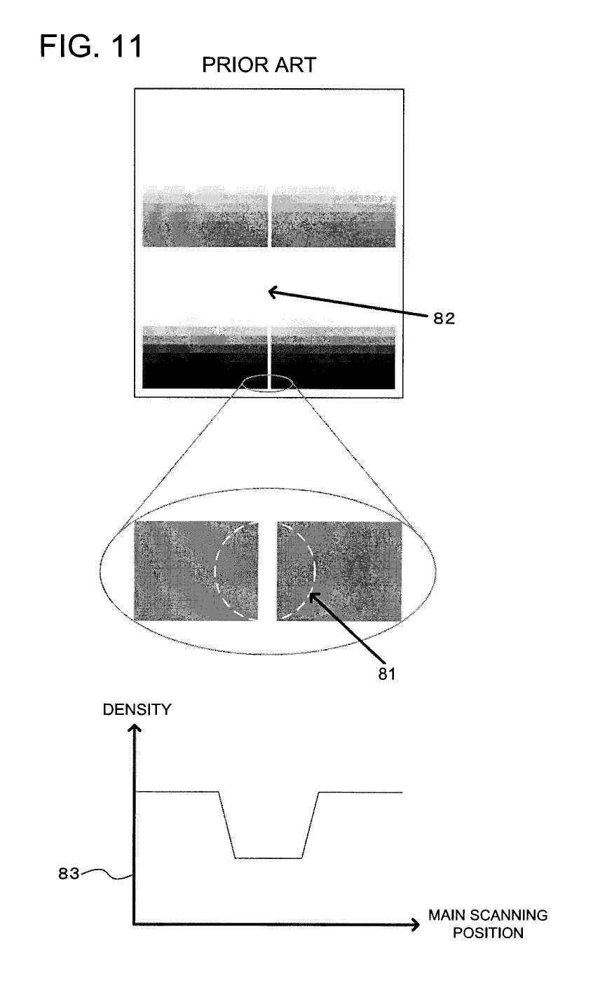

In a patch pattern 80 serving as a measurement chart having been conventionally used, when an image in the patch is partially lacked as shown in FIG. 11, the effect thereof has been noted in density measurement. This results from the fact that when the density of the patch pattern 80 is measured with a colorimeter, the unit measurement region 81 of the measurement instrument has relatively large range. For example, in cases in which streak unevenness 82 is generated to the extent that an image in the patch is partially lacked, when the patch is measured, a measurement result of the average density is obtained in which streak unevenness 82 is contained in a portion other than streak unevenness 82 intended to be originally measured, and thereby, as shown in graph 83 of the measurement results of density, lower density is measured.

Even in the method disclosed in Unexamined Japanese Patent Application Publication No. 4-215672 in which in a non-image region located in the side portion of the image region of a photoreceptor, a large number of black linear patterns are formed and then based on the detected value of reflective light from a plurality of linear patterns present in a unit measurement region, toner density is calculated, since a plurality of linear patterns are contained in the unit measurement region, average density containing a lacked portion is eventually calculated in the case of lack of one line or partial lack.

The present invention is intended to solve the above problems and an object thereof is to provide an image forming apparatus and a density unevenness detection device capable of measuring density with no effect by a portion where an image in a measurement chart is lacked.

### SUMMARY

[1] To achieve at least one of the above mentioned objects, an image forming apparatus reflecting one aspect of the present invention comprises: an image forming section to subject image formation of a linear test pattern; a measurement section to measure a line width of one line of the linear test pattern at a plurality of measurement points; and a detection section to detect density unevenness, wherein the detection section converts the measured line width into density and, eliminates a measurement point where the measured line width thereof is less than a predetermined value to detect density unevenness in an extending direction of the linear test pattern.

In the above invention, a linear test pattern is subjected to image formation as a measurement chart to read information of the image. The line width of one line of the read image is directly measured at a plurality of measurement points, and then measurement point where the line widths thereof is less than a predetermined value are eliminated to derive density from the correlativity between line width and density. Thereby, even when the image of the measurement chart is partially lacked, with no effect thereof, the density of the line can be determined, whereby from a gradation value for setting and the determined density, density unevenness can be detected.

[2] In the abovementioned image forming apparatus of item 1,

wherein the image forming section repeats an image forming operation per line in a main scanning direction as an image forming position is allowed to move in a sub scanning direction at a right angle to the main scanning direction to form a two-dimensional image, and the linear test pattern contains lines extending in the main scanning direction.

In the invention of item 2, since an image forming operation per line in the main scanning direction is repeated as the image forming position is allowed to move in the vertical scanning direction at right angles to the main scanning direction, density unevenness of the main scanning direction appears in any location of the vertical scanning direction in the same manner. Thereby, when a line extending in the main scanning direction is formed in a certain position of the vertical scanning direction and then the density unevenness of the main scanning direction of the line is detected, density unevenness of the main scanning direction in the entire two-dimensional image is detected.

[3] In the abovementioned image forming apparatus of item 1,

wherein a resolution of the measurement section in the direction at a right angle to the extending direction of the linear test pattern is at least twice a resolution of the image forming section in the direction at the right angle to the extending direction of the linear test pattern.

In the invention of item 3, to measure fluctuation portions of the line width, the resolution of the direction at a right angle to the extending direction of the linear test pattern of the measurement section is allowed to be at least twice a resolution of the above direction of the image forming section.

[4] In the abovementioned image forming apparatus of item 1,

a correction value calculation section to calculate a correction value to offset density unevenness detected by the detection section, a memory section to memorize the correction value calculated by the correction value calculation section, and a correction section to correct image data to be provided for the image forming section based on the collection value memorized in the memory section.

In the invention of item 4, a correction value in which density unevenness calculated from a gradation value for setting and a detected line density is offset is calculated and memorized. During image output, using the correction value, image data is corrected and output.

[5] In the abovementioned image forming apparatus of item 1,

wherein the image forming section outputs the linear test pattern by image formation onto a recording sheet, the measurement section is a reading device to read optically an image on the recording sheet on which the linear test pattern is subjected to image formation and to acquire image data.

In the invention of item 5, a measurement chart containing a linear test pattern is subjected to image formation onto a recording sheet and then the image data thereof is optically read.

[6] To achieve at least one of the above mentioned objects, a density unevenness detection device reflecting one aspect of the present invention comprises; an output section to output data of a linear test pattern: an acquisition section acquires image data which is obtained and read the linear test pattern with a predetermined reading device in which the linear test pattern is subjected to image formation by a predetermined image forming apparatus based on the data to be output by the output section: a detection section to measure a line width of one line of the linear test pattern at a plurality of measurement points by which image formation is carried out with the image forming apparatus based on the image data acquired by the acquisition section, to convert the measured line width into density, and to eliminate a measurement point where the measured line width thereof is at most a predetermined value to detect density unevenness in an extending direction of the linear test pattern on the image forming apparatus.

In the invention of item [6], the density unevenness detection device allows an external image forming apparatus to subject image formation of a linear test pattern and based on data obtained via measurement thereof by a detection section, density unevenness resulting of the image forming apparatus is detected. Since a density unevenness detection device is provided separately from an image forming apparatus, a density unevenness examination for any image forming apparatus or a plurality of image forming apparatuses can be performed using a single density unevenness detection device. The effect thereof is the same as in [1].

[7] In the abovementioned density unevenness detection device of item 6,

wherein the image forming apparatus repeats an image forming operation per line in a main scanning direction as an image forming position is moved in a sub scanning direction at a right angle to the main scanning direction to form a two-dimensional image, and the linear test pattern contains lines extending in the main scanning direction.

In the invention of item [7], in the same manner as in item [2], when density unevenness of one line of the main scanning direction is detected, density unevenness of the main scanning direction in an entire two-dimensional image is detected.

[8] In the abovementioned density unevenness detection device of item 6,

wherein a resolution of the reading device in the direction at a right angle to the extending direction of the linear test pattern is at least twice a resolution of the image forming apparatus in the direction at the right angle to the extending direction of the linear test pattern.

In the invention of item [8], the resolution of the direction at a right angle to the extending direction of a linear test pattern of the detection section separately provided in [6] is at least twice the resolution of the direction of the image forming apparatus separately provided in the same manner. Thereby, fluctuation portions of the line width can be measured.

[9] In the abovementioned density unevenness detection device of item 6 further includes, a correction value calculation section to calculate a correction value to offset density unevenness detected by the detection section, a memory section to memorize the correction value calculated by the correction value calculation section, and a correction section to correct image data to be provided for the image forming apparatus based on the correction value memorized in the memory section.

In the invention of item [9], a correction value is calculated and memorized in which a gradation value for setting outputted to the image forming apparatus provided separately and line width read by the measurement section separately provided are input to a processing section and then density unevenness calculated from line density having been detected is offset. During image data output, using the correction value, image data is corrected and output.

### BRIEF DESCRIPTION OF THE INVENTION

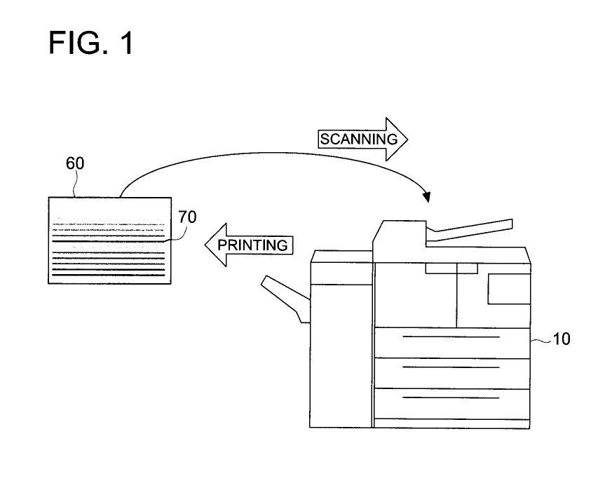

FIG. 1 is an illustration view showing a workflow during detection of density unevenness using an image forming apparatus according to an embodiment of the present invention;

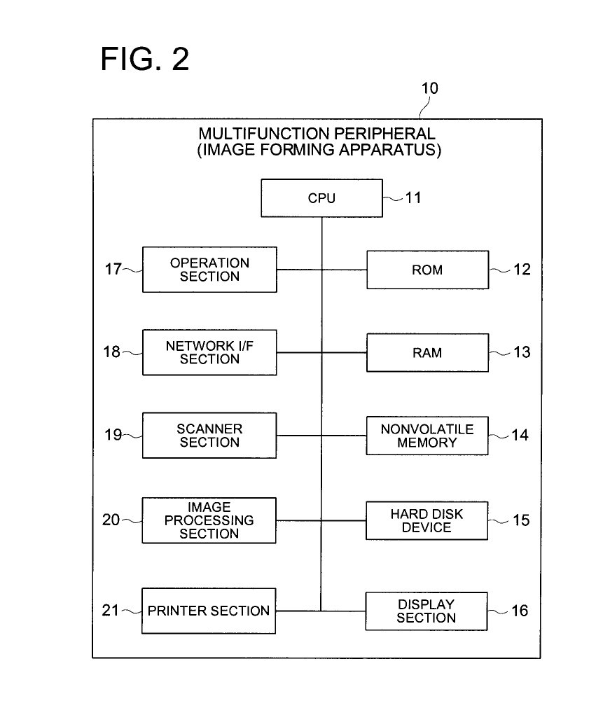

FIG. 2 is a block diagram showing the schematic constitution of the image forming apparatus according to the embodiment of the present invention;

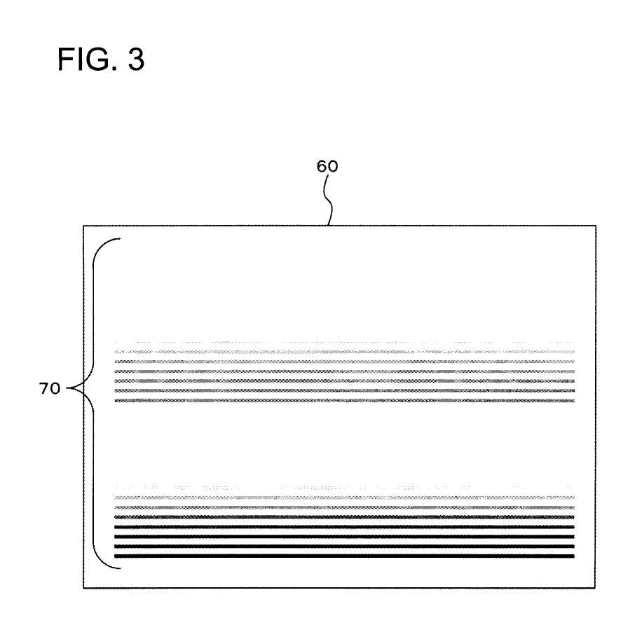

FIG. 3 is an illustration view showing one example of a measurement chart containing a linear test pattern;

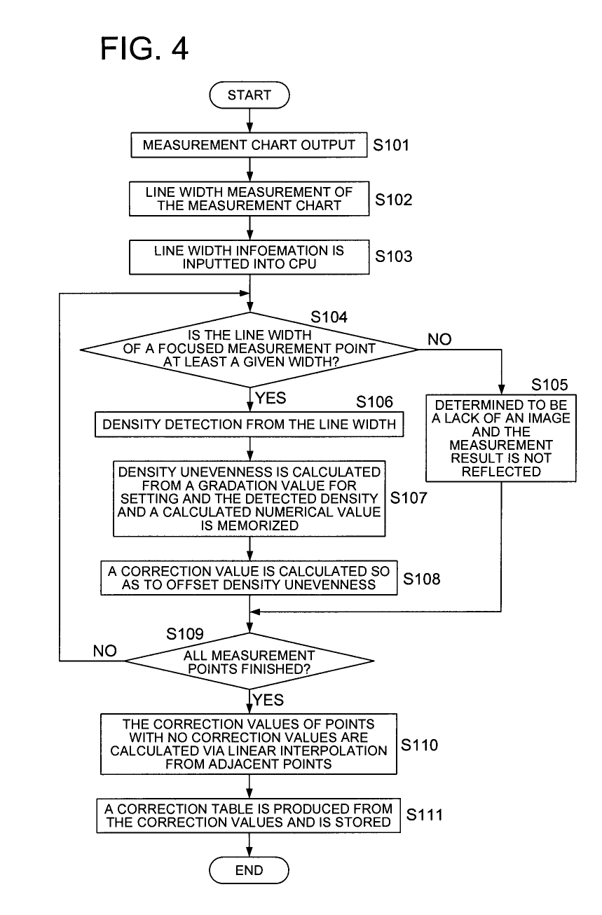

FIG. 4 is a flowchart showing detection correction processing for density unevenness performed by the image forming apparatus according to the embodiment of the present invention;

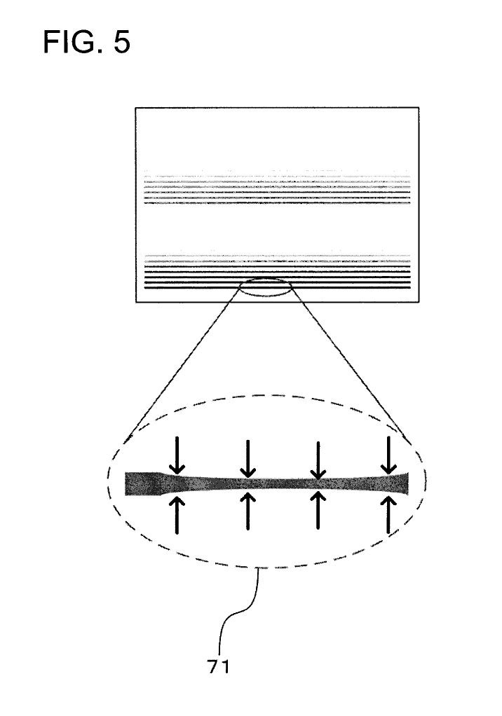

FIG. 5 is an illustration view showing the measurement method of a line width of a measurement chart;

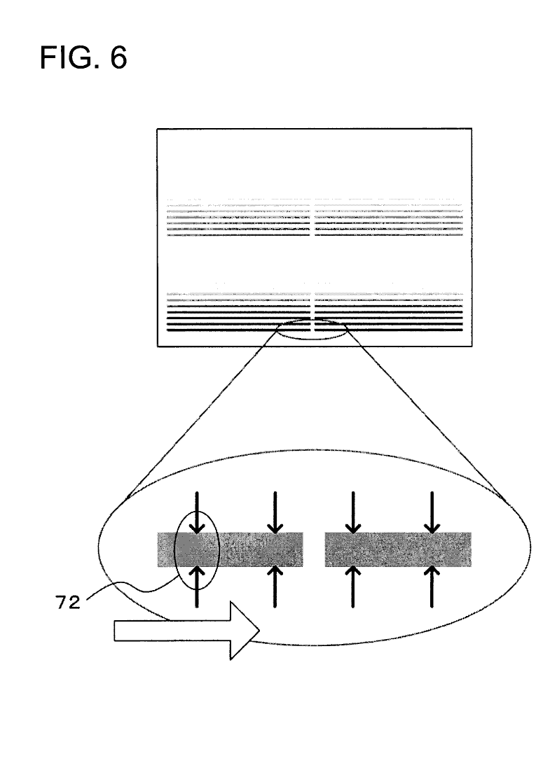

FIG. 6 is an illustration view showing the order of focused measurement points in the embodiment of the present invention;

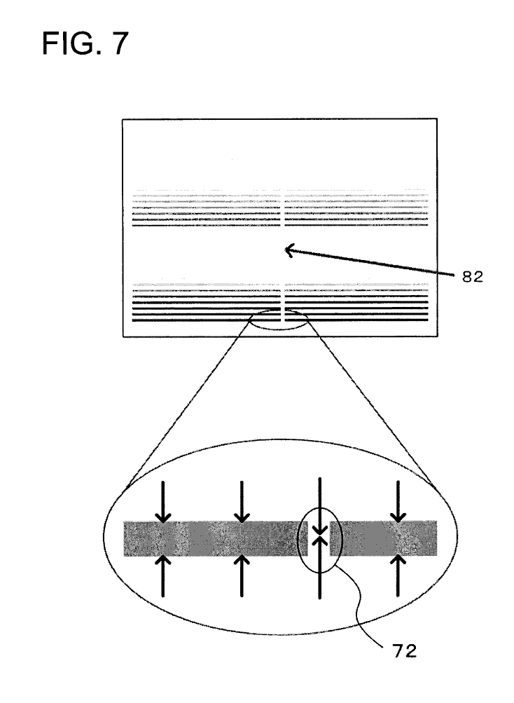

FIG. 7 is an illustration view showing one example of a measurement chart in which streak unevenness occurs at a measurement point in the embodiment of the present invention;

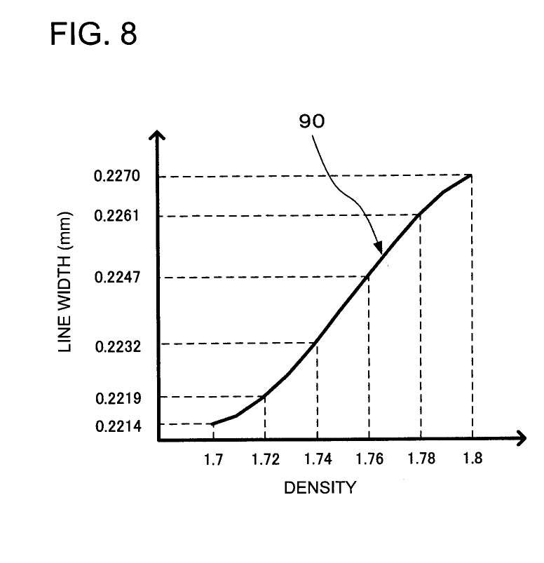

FIG. 8 is an illustration view in which the correspondence relationship between density and line width is graphed;

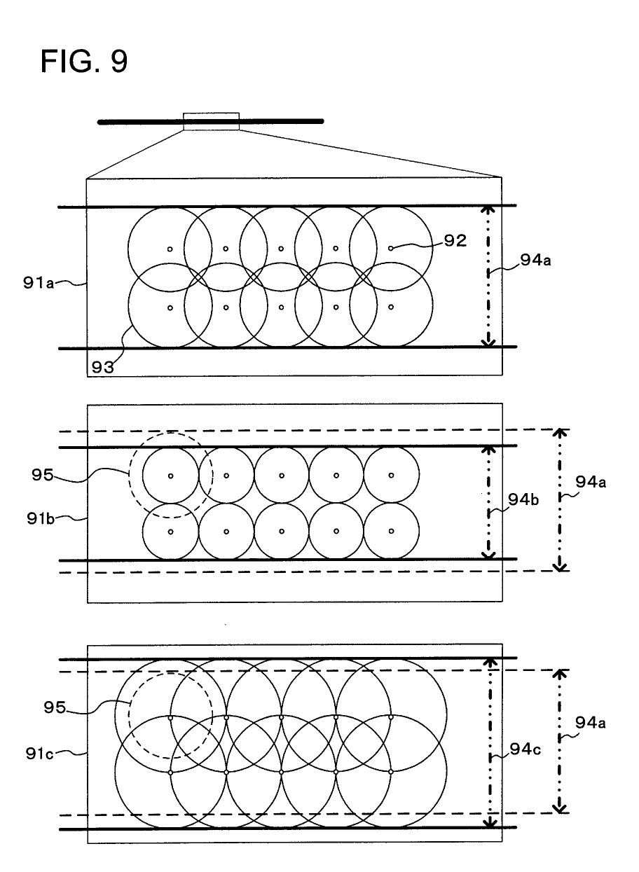

FIG. 9 is an illustration view showing the principle that line width is changed with density;

FIG. 10 is an illustration view showing one example of a measurement chart containing a conventional patch pattern; and

FIG. 11 is an illustration view showing the case of occurrence of streak unevenness and the measurement results in density measurement of a conventional patch pattern.

### DESCRIPTION OF THE PREFERRED EMBODIMENT

An embodiment of the present invention will now be described with reference to the drawings.

FIG. 1 shows a workflow during detection of density unevenness using an image forming apparatus 10 according to the embodiment of the present invention. The image forming apparatus 10 is a so-called multifunction peripheral provided with functions to execute jobs such as a copying job in which an original document is optically read and a reproduced image is formed on a recording sheet, a scanning job in which image data of the read original document is stored in a file and transmitted to an external device, and a PC printing job in which an image relevant to print data having been received from a terminal device such as a personal computer is formed on a recording sheet. The image forming apparatus 10 repeatedly forms an image per line in the main scanning direction as the position is shifted in the vertical scanning direction at right angles to the main scanning direction to form a two-dimensional image on a recording sheet.

Further, the image forming apparatus 10 is provided with a function to form an image of a measurement chart 60 to measure and correct density unevenness of the main scanning direction during image formation on a recording sheet. The measurement chart 60 is subjected to image formation in the state where a plurality of color linear test patterns 70 is arranged with a mutual space.

In the image forming apparatus 10, the measurement chart 60 having been subjected to image formation is read using the scanner; the image data is analyzed to measure the line width of each color linear test pattern 70; and this measured line width is converted into density to determine density unevenness in image formation of the image forming apparatus 10.

FIG. 2 shows the schematic constitution of the image forming apparatus 10. The image forming apparatus 10 is provided with a CPU (Central Processing Unit) 11 to totally control the operation of the image forming apparatus 10, a ROM (Read Only Memory) 12 connected to the CPU 11, a RAM (Random Access Memory) 13, a nonvolatile memory 14, a hard disk device 15, a display section 16, an operation section 17, a network I/F section 18, a scanner section 19, an image processing section 20, and a printer section 21 as an example of an image forming section.

The CPU 11 is based on an OS program and thereon, middleware and application programs are executed. Various kinds of program are stored in the ROM 12, and in accordance with these programs, the CPU 11 executes processings to realize each function of the image forming apparatus 10 such as job executions. The RAM 13 is used as a work memory to temporarily store various kinds of data and as an image memory to store image data when the CPU 11 executes programs.

Further, the CPU 11 acquires line width information from an image of a measurement chart 60 having been read by the scanner section 19 using a dedicated application to determine density unevenness and a correction value therefor and corrects print data based on the correction value.

The nonvolatile memory 14 is a rewritable memory (a flash memory) in which a memory can be retained even when the power supply is switch off. In the nonvolatile memory 14, device-inherent information and items of setting information are memorized. The hard disk device 15 is a nonvolatile memory device having large capacity in which the OS program, various kinds of application programs, print data, image data, and job history are stored.

The operation panel of the image forming apparatus 10 is constituted of a display section 16 and an operation section 17. The display section 16 incorporates a liquid crystal display (LCD) and functions to display various kinds of operation screen and setting screen. The operation section 17 functions to receive various kinds of operation such as job input and setting from the user. The operation section 17 is constituted of a touch panel, provided on the screen of the display section 16, to detect a pressed coordinate position, as well as a ten key, a character input key, and a start key.

The network I/F section 18 communicates with other external devices connected via a network such as LAN (Local Area Network).

The scanner section 19 functions to optically read an original document to acquire image data. The scanner section 19 is constituted of; for example, a light source to irradiate an original document with light, a line image sensor to receive reflective light therefrom to read one line of the original document in the transverse direction, a moving member to sequentially move the reading position of a line unit in the longitudinal direction of the original document, an optical path containing a lens and a mirror to introduce reflective light from the original document to the line image sensor to be focused, and a conversion section to convert an analog image signal output by the line image sensor into digital image data. When an image of the measurement chart 60 is read, the line width of the image needs to be read minutely. Therefore, the reading resolution in the scanner section 19 is at least twice the resolution of image formation in the printer section 21.

The image processing section 20 carries out rasterizing processing to convert print data into image data and compression and expansion processing of image data, other than processings such as enlargement and reduction or rotation of an image.

The printer section 21 functions to form an image corresponding to image data on a recording sheet, being, herein, configured as a so-called laser printer in which a conveyance device of recording sheets, a photoreceptor drum, a charging device, a laser unit, a developing device, a transfer separation device, a cleaning device, and a fixing device are provided to carry out image formation via an electrophotographic process. Image formation may be carried out using an ink-jet system or another system.

FIG. 3 shows one example of a measurement chart 60. In a linear test pattern 70 constituting the measurement chart 70, color lines of a plurality of gradations are formed, in the main scanning direction, for each color of yellow (Y), magenta (M), cyan (C), and black (K) to form a color image. In the present example, in the figure, a plurality of lines differing from each other in gradation value are arranged from the top in ascending order of gradation value with respect to 4 colors of YMCK. Image data of the measurement chart 60 is memorized in the nonvolatile memory 14 in advance.

The lines constituting the linear test pattern 70 each have a predetermined uniform width (4 dots in the present example). Each line has one gradation value and extends in the direction to detect density unevenness. Further, the line needs not to be continuous. The line may be a dashed line and needs only to exist on the measurement point.

Next, the operation of the image forming apparatus 10 will be described.

FIG. 4 is a flowchart showing detection correction processing for density unevenness performed by the image forming apparatus 10. This operation is initiated when the user (an administrator) has instructed the image forming apparatus 10 to output a measurement chart 60.

The image forming apparatus 10 receives a measurement chart output instruction as shown in FIG. 3 via the operation section 17 and then reads out image data of the measurement chart 60 memorized in the nonvolatile memory 14 to print the image data on a recording sheet using the printer section 21 (step S101).

The user allows the scanner section of the image forming apparatus 10 to read an image on the recording sheet on which this measurement chart 60 has been printed. The CPU 11 utilizes a dedicated application memorized in the ROM 12 and then analyzes the read image to directly measure line width as shown in an enlarged manner by a dashed-line ellipse 71 of FIG. 5 (step s102). In line width measurement, the line widths of a plurality of measurement points previously determined may be measured or the line widths of all the points in the entire longitudinal direction of the line may be measured. In the following processings, one line is processed. In this embodiment, the CPU 11 and the scanner section 19 constitute the measurement section.

The CPU acquires a measurement value of line width (step S 103) and then, as shown in FIG. 6, sequentially carries out the following processings with respect to a plurality of measurement points lined up with a predetermined space from one end side toward the other end side of the main scanning direction. Initially, it is examined whether the line width of a certain focused measurement point 72 has a width of at least a given width. As shown by the focused measurement point 72 of FIG. 7, when no width of at least a given width is possessed (step S104; No), the image of the measurement point where the measurement value has been obtained is determined to lack as shown as streak unevenness 82 (refer to FIG. 7), and then the measurement result is not reflected (step S105) to advance to step S109.

When the line width of the focused measurement point 72 has a width of at least a given width (step S104; Yes), based on graph 90 showing the relationship between line width and density as shown in FIG. 8, conversion is carried out into a density for the line width of the focused measurement point 72 (step S106). The difference between the density and a gradation value for setting (a gradation value of the line in print data of the measurement chart) is detected as density unevenness (step S107) and then a correction value is calculated so as to offset the density unevenness. The numerical value is memorized in a correction value memory area provided for the RAM 12 (step S108) to advance to step S 109. In this embodiment, the detection section is constituted from the CPU 11 and the dedicated application. And the correction value calculation section and correction section are constituted from the CPU 11 and the dedicated application.

FIG. 8 shows, using a graph, the relationship between density and line width when the resolution of the printer section is 600 dpi with respect to a 4-dot line.

FIG. 9 is an illustration view showing the principle that line width is changed with density, in which 3 line segments 91a, 91b, and 91c having different density are enlarged. Line segments 91a, 91b, and 91c are obtained by printing lines having the same line width in print data. Line segment 91b is set to have smaller density than line segment 91a, and line segment 91c is set to have larger density than line segment 91a. Center point 92 of each dot is arranged in the main scanning direction in parallel at equal spaces, and the distance from the center point of a dot adjoining in the vertical scanning direction is equal with respect to each dot. Further, in line segments 91b and 91c, dot 95 constituting line segment 91a and line width 94a of line segment 91a are shown for reference with dashed lines . . . differing in thickness. Since the size of one dot 93 varies with density, compared with line width 94a of line segment 91a, line width 94b of line segment 91b having relatively small density decreases and line width 94c of line segment 91c having relatively large density increases. As dot density increases, the size of one dot 93 increases, resulting in an increase in line width for the increased portion of the diameter of the dot. Measured line width is converted into density. Thereby, the thickness of each line of the linear test pattern 70 may be appropriately determined in the range where density is detectable. Namely, since the line width of one line depends only on the dot size of both ends of the width direction, the line width of one line may contain 2 dots or 3 dots, even 100 dots in an extreme case. The line width varies depending on density, regardless of thickness setting.

In the case where measurement of all the measurement points has not yet terminated (step S109; No), a next measurement point is set as a focused measurement point 72 to return to step S104.

When measurement of all the measurement points has been terminated (step S109; Yes), the correction values of points with no correction values with respect to all the points (pixels) of the main scanning direction are calculated via linear interpolation from the correction values of adjacent measurement points having correction values (step S110) and then from the correction values, a correction table is produced, followed by being stored in the nonvolatile memory 14 for operation termination.

When image formation is carried out using the image forming apparatus 10, the CPU 11 corrects and outputs image data based on this correction table.

As described above, with avoiding the effect of lacked portions of an image of the measurement chart, density can be measured.

The embodiment of the present invention has been described with reference to the drawings. Specific configurations are not limited to those shown in the embodiment. Various changes and additions without departing from the gist of the present invention fall within the scope of the present invention.

In the embodiment, by the operation section 17 of the image forming apparatus 10, the instruction of output of a measurement chart was issued but this may be made by an external device. If image data of a measurement chart 60 is input to the image forming apparatus 10 from an external device, the data needs not to be memorized in the nonvolatile memory 14.

In the embodiment, a measurement chart 69 was subjected to image formation on a recording sheet. However, the medium is not limited to such a recording sheet but another medium such as an intermediate transfer belt or a photoreceptor drum is employable. In this case, for measurement of the line widths of lines formed on the intermediate transfer belt or the photoreceptor drum, a dedicated measurement section is provided. For example, an illumination lamp and a CCD (Charge Coupled Device) image sensor are arranged in the measurement point of the intermediate transfer belt or the photoreceptor drum. Another measurement method is employable.

In the embodiment, lines of the linear test pattern 70 were formed in the main scanning direction. However, in the case of a direction where density unevenness is detectable, another direction such as the vertical scanning direction is employable. For example, lines of the vertical scanning direction may be formed on an intermediate belt or a photoreceptor drum to detect density unevenness of the vertical scanning direction.

In the embodiment, the image forming apparatus 10 carried out image formation of a measurement chart, as well as reading its image data and measuring line width, but these may be carried out by an external device. A configuration may be made as a density unevenness detection device provided with a function to output image data of a measurement chart to an image forming apparatus and a function in which image data having been obtained by reading, using an external device, the measurement chart having been subjected to image formation by this image forming apparatus is input; line width is determined via image analysis thereof; and density unevenness is detected. Further, it is possible that this device is provided with a function to derive a correction value and a function to output correction value data to, for example, an image forming apparatus or the printer driver of a personal computer as a profile.

In the embodiment, measurement points of line width were measured in order from one end, but in the order of measurement, another one is employable. Further, in setting of measurement points, any appropriate setting is employable depending on the type of a measured line. For example, when the density of a dotted line is examined, measurement points are preferably set on the line.

In the case of a method to directly measure line width, but not in the case of an indirect method such that line width is determined from density such as reflectance, the measurement method of line width is not limited to the method of image analysis via reading using a scanner. Further, the unit measurement width in the line direction is preferably small at a maximum extent and it is critical to be smaller than at least a lacked portion of a line which may be generated. Measurement is preferably carried out for a width of at most 1 dot unit Still further, to read the width of a line, the resolution of the direction at right angles to the line is required to have high resolution. Therefore, in the case of a scanner, the resolutions of both the main scanning direction and the vertical scanning direction are preferably at least twice the resolution of the printer section.

An image forming apparatus and a density unevenness detection device according to the present embodiment make it possible that even when an image of a measurement chart is partially lacked, density unevenness is detected with no effect thereof.

What is claimed is:

1. An image forming apparatus comprising:
an image forming section to carry out image formation of a linear test pattern;
a measurement section to measure a line width of one line of the linear test pattern at a plurality of measurement points; and
a detection section to detect density unevenness,
wherein the detection section converts the measured line width into density and, eliminates a measurement point where the measured line width thereof is at most a predetermined value to detect density unevenness in an extending direction of the linear test pattern.

2. The image forming apparatus of the claim 1,
wherein the image forming section repeats an image forming operation per line in a main scanning direction as an image forming position is allowed to move in a sub scanning direction at right angles to the main scanning direction to form a two-dimensional image, and
the linear test pattern contains lines extending in the main scanning direction.

3. The image forming apparatus of the claim 1,
wherein a resolution of the measurement section in the direction at right angles to the extending direction of the linear test pattern is at least twice a resolution of the image forming section in a direction at right angles to the extending direction of the linear test pattern.

4. The image forming apparatus of the claim 1 further comprises,
a correction value calculation section to calculate a correction value to offset density unevenness to be detected by the detection section,
a memory section to memorize the correction value to be calculated by the correction value calculation section, and
a correction section to correct image data to be provided for the image forming section based on the correction value memorized in the memory section.

5. The image forming apparatus of the claim 1,
wherein the image forming section outputs the linear test pattern by image formation onto a recording sheet,
the measurement section is a reading device to read optically an image on the recording sheet on which the linear test pattern is subjected to image formation and to acquire image data.

6. A density unevenness detection device comprising;
an output section to output data of a linear test pattern:
an acquisition section acquires image data which is obtained and read the linear test pattern with a predetermined reading device in which the linear test pattern is subjected to image formation by a predetermined image forming apparatus based on the data to be output by the output section:
a detection section to measure a line width of one line of the linear test pattern at a plurality of measurement points by which image formation is carried out with the image forming apparatus based on the image data acquired by the acquisition section, to convert the measured line width into density, and to eliminate a measurement point where the measured line width thereof is at most a predetermined value to detect density unevenness in an extending direction of the linear test pattern on the image forming apparatus.

7. The density unevenness detection device of the claim 6,
wherein the image forming apparatus repeats an image forming operation per line in a main scanning direction as an image forming position is moved in a sub scanning direction at right angles to the main scanning direction to form a two-dimensional image, and
the linear test pattern contains lines extending in the main scanning direction.

8. The density unevenness detection device of the claim 6,
wherein a resolution of the reading device in the direction at right angles to the extending direction of the linear test pattern is at least twice a resolution of the image forming apparatus in a direction at right angles to the extending direction of the linear test pattern.

9. The density unevenness detection device of the claim 6 further comprises,
a correction value calculation section to calculate a correction value to offset density unevenness to be detected by the detection section,
a memory section to memorize the correction value to be calculated by the correction value calculation section, and
a correction section to correct image data to be provided for the image forming apparatus based on the correction value memorized in the memory section.
